(19) United States
(12) Patent Application Publication
(10) Pub. No.: US 2019/0037339 A1
(43) Pub. Date: Jan. 31, 2019

(54) METHOD AND APPARATUS FOR FACILITATING LOCATION BASED SERVICES AND/OR LOCATION BASED POLICY CONTROL

(71) Applicant: Telefonaktiebolaget LM Ericsson (publ), Stockholm (SE)

(72) Inventors: Chunmiao LIU, SHANGHAI (CN); Venkata Ramesh BALABHADRUNI, KISTA (SE); Ping CHEN, SHANGHAI (CN); Chunbo WANG, SHANGHAI (CN); Chengqiong XIE, SHANGHAI (CN)

(21) Appl. No.: 16/071,995

(22) PCT Filed: Jan. 29, 2016
(86) PCT No.: PCT/CN2016/072828

§ 371 Date: Jul. 23, 2018

(51) Int. Cl. H04W 4/02; H04L 12/24; H04L 29/06; H04L 29/12; H04L 12/14

(52) U.S. Cl. CPC H04W 4/02; H04L 41/0893; H04L 65/1016; H04W 84/12; H04L 12/1407; H04L 61/609; H04L 61/2007

(57) ABSTRACT

Embodiments of the present disclosure provide methods, apparatus and computer program product for facilitating location based services and/or location based policy control. A method at a first network node comprises receiving a message from a terminal connected to the first network node via non-3GPP access, the message including a local IP address or both the local IP address and a port number of the terminal; and sending geographical location related information of the terminal to an IMS network via at least a network node for policy control function of the IMS network. Methods at other network nodes and corresponding apparatus are also provided. With the embodiments, location based services and/or policy control may be provided to non-3GPP access devices.

### TECHNICAL FIELD

The non-limiting and exemplary embodiments of the present disclosure generally relate to communication networks, and specifically to methods, apparatuses, and computer program products for facilitating location based services and/or location based policy control for terminals with non-3GPP access, for example with Wireless Fidelity (Wi-Fi) access.

### BACKGROUND

This section introduces aspects that may facilitate better understanding of the present disclosure. Accordingly, the statements of this section are to be read in this light and are not to be understood as admissions about what is in the prior art or what is not in the prior art.

Wi-Fi and cellular communication such as Global System for Mobile Communications (GSM), Wideband Code Division Multiple Access (WCDMA), Long Term Evolution (LTE) and LTE-Advanced (LTE-A) both are successful wireless technologies which have been widely used. Wi-Fi refers to a wireless local network based on 802.11 standard developed by Institute of Electrical and Electronic Engineers (IEEE). Cellular network, for example LTE developed by the 3rd Generation Partnership Project (3GPP), operates on licensed frequency band, and each operator of a cellular network may be allocated only a very limited frequency band for exclusive use. With increasing demand for high data rate and capacity, available licensed bands become more and more scarce. In contrast, Wi-Fi operates on unlicensed frequency band and this has been regarded as an important advantage of Wi-Fi. Another advantage of Wi-Fi is that it is suitable for providing high capacity and low mobility indoor coverage. Due to these advantages, Wi-Fi has been considered as a complementary wireless access technology to cellular communication to form a converged network. For example, 3GPP is developing standards for supporting untrusted non-3GPP access networks, such as Wi-Fi. FIG. 1 illustrates a converged network 100 where a terminal 101 may connect to an Evolved Packet Core (EPC) 105 and an IP Multimedia Subsystem (IMS) network 104 via a 3GPP radio access network 102 and/or a Wi-Fi access 103.

A feature of Wi-Fi calling, also referred to as Voice over Wi-Fi (VoWiFi), enables a voice call over any Wi-Fi access in line with 3GPP standards for “untrusted non-3GPP access network”. Many operators are going to deploy the feature or have shown their interest. Furthermore, to make this feature more attractive, operators also want to provide similar or same location based services and/or location based policy control for VoWiFi, as they do for Voice over LTE (VoLTE) in 3GPP.

Location based services and/or location based policy control/applications are becoming more and more attractive, and 3GPP has developed standard for network provided location information to the IMS network, for example 3GPP TS 29.214 Release 12. For instance, location information of a terminal accessed via a 3GPP LTE network may be retrieved from a Home Subscriber Server (HSS) or a Home Location Register (HLR), or may be retrieved from a Policy and Charging Rule Function (PCRF) via a Rx interface, and then location based services and/or location based policy control may be provided for VoLTE.

In VoWiFi, voices are transmitted to the IMS network as data packets, and then the IMS network processes these data packets and distinguishes voice data from signaling. Therefore, to enable location based services and/or location based policy control for VoWiFi, location information of a terminal has to be provided to the IMS network.

Currently, there is no standard way for the network side to obtain user location information for VoWiFi over public untrusted Wi-Fi access. In a case where the subscriber identity module (SIM)-based UE also registers in a 3GPP network when it connects via untrusted Wi-Fi access, the IMS network side can obtain location of the end user by retrieving 3GPP location information as an alternative. However, such case may not always be applicable. For example, there may be no 3GPP coverage or the user may not register in a 3GPP network due to no roaming agreement with the visited Public Land Mobile Network (PLMN) when being abroad. Due to this, a lot of location based services and/or location based policy control cannot be applied for VoWiFi in the same way as that for VoLTE. Similar problems exist for terminals with other non-3GPP access.

Therefore, there is a need for an efficient solution to enable location based services and/or location based policy control in the IMS network for terminals with non-3GPP access, e.g., Wi-Fi access.

### SUMMARY

Various embodiments of the present disclosure mainly aim at providing an efficient solution to enable location based services and/or location based policy control in an IMS network for terminals with non-3GPP access. Other features and advantages of embodiments of the present disclosure will also be understood from the following description of specific embodiments when read in conjunction with the accompanying drawings, which illustrate the principles of embodiments of the present disclosure.

In a first aspect of the present disclosure, a method at a first network node for facilitating location based services and/or location based policy control is provided. The method comprises: receiving a message from a terminal connected to the first network node via non-3GPP access, the message including a local IP address or both the local IP address and a port number of the terminal; and providing geographical location related information of the terminal to an IMS network via at least a network node for policy control function of the IMS network.

In one embodiment, receiving a message from a terminal may comprise: receiving an authentication request message from the terminal during an attach procedure of the terminal.

In another embodiment, the method may further comprise obtaining a geographical location of the terminal based on at least the local IP address. In a further embodiment, obtaining the geographical location of the terminal based on at least the local IP address may comprise: transmitting the local IP address or both the local IP address and the port number to a second network node, and receiving from the second network node the geographical location derived from at least the local IP address. In a further embodiment, the first network node may be an Evolved Packet Data Gateway (ePDG), and the second network node may be an Authentication Authorization and Accounting (AAA) server, and wherein transmitting the local IP address or both the local IP address and the port number to a second network node may comprise: transmitting the local IP address or both the local IP address and the port number to the AAA server in a Diameter-EAP-Request (DER) request message, and wherein receiving from the second network node the geographical location derived from at least the local IP address may comprise: receiving the geographical location from the AAA server in a DER response message.

In one embodiment, providing geographical location related information of the terminal to an IMS network via at least a network node for policy control function of the IMS network may comprise: sending the geographical location related information via a Packet Data Network Gateway (PGW) to a Policy and Charging Rule Function (PCRF) during a Policy and Charging Control (PCC) session creation or update procedure.

In another embodiment, the geographical location related information of the terminal may comprise at least one of: the obtained geographical location, the local IP address, and both the local IP address and the port number.

In a second aspect of the present disclosure, a method for facilitating location based services and/or location based policy control is provided. The method may be performed by a second network node. The method comprises: receiving a local IP address or both the local IP address and a port number of a terminal from a first network node to which the terminal is connected via non-3GPP access, deriving a geographical location of the terminal based on at least the local IP address; and transmitting the derived geographical location to the first network node so as to enable the first network node to send the geographical location to an IMS network.

In one embodiment of the present disclosure, receiving a local IP address or both the local IP address and a port number of a terminal from a first network node may comprise receiving the local IP address or both the local IP address and the port number from an ePDG in a DER request message, and wherein transmitting the derived geographical location to the first network node may comprise transmitting the geographical location to the ePDG in a DER response message.

In another embodiment, deriving a geographical location of the terminal based on at least the local IP address may comprise translating the local IP address or both the local IP address and the port number to the geographical location through a database.

In a third aspect of the present disclosure, a method for facilitating location based services and/or location based policy control is provided. The method comprises receiving a message from a first network node, the message comprising geographical location related information of a terminal connected to the first network node via non-3GPP access; and providing the geographical location related information to an IMS network via at least a network node for policy control function of the IMS network.

In one embodiment, receiving a message from a first network node may comprise receiving a session creation request message from an ePDG.

In another embodiment, providing the geographical location related information to an IMS network via at least a network node for policy control function of the IMS network may comprise transmitting the geographical location related information to a Policy and Charging Rule Function (PCRF) during a Policy and Charging Control (PCC) session creation or update procedure.

In yet another embodiment, the geographical location related information may comprise at least one of: a local IP address of the terminal, both the local IP address and a port number of the terminal, and a geographical location of the terminal derived from at least the local IP address.

In a fourth aspect of the present disclosure, a method for facilitating location based services and/or location based policy control is provided. The method comprises receiving a message from a first network node, the message comprising geographical location related information of a terminal connected to the first network node via non-3GPP access; and transmitting the geographical location related information of the terminal to an IMS network.

In one embodiment, receiving a message from a first network node may comprise receiving a PCC session creation or update message from a PGW.

In another embodiment, transmitting the geographical location related information to the IMS network may comprise transmitting the geographical location related information to the IMS network during an IMS registration or call procedure.

In yet another embodiment, the method may further comprise receiving an Authentication Authorization-Request (AAR) message from a Proxy-Call Session Control Function (P-CSCF) requesting user location information; and wherein transmitting the geographical location related information to an IMS network may comprise transmitting an Authentication Authorization-Answer (AAA) message or a Re-authentication Request (RAR) message including the geographical location related information to the P-CSCF in response to the received AAR message.

In yet another embodiment, the geographical location related information may comprise at least one of: a local IP address of the terminal, both the local IP address and a port number of the terminal, and a geographical location of the terminal derived from at least the local IP address.

In a fifth aspect of the present disclosure, a method for facilitating location based services and/or location based policy control is provided. The method comprises transmitting a request to a first network node requesting user location information of a terminal accessed via non-3GPP access; receiving geographical location related information of the terminal from the first network node in response to the requesting, and transmitting the geographical location related information of the terminal to an IMS core.

In one embodiment, the method may further comprise receiving a Session Initiation Protocol (SIP) REGISTER message from the terminal, and determining the access type of the terminal based on the received SIP REGISTER message; and wherein transmitting a request to a first network node may comprise transmitting an Authentication Authorization-Request (AAR) message to a PCRF requesting for the user location information of the terminal if the access type of the terminal is determined as non-3GPP access; and wherein receiving geographical location related information of the terminal from the first network node may comprise receiving from the PCRF an Authentication Authorization-Answer (AAA) message or a Re-authentication Request (RAR) message including the geographical location related information of the terminal.

In another embodiment, transmitting the geographical location related information of the terminal to an IMS core may comprise transmitting a SIP REGISTER message including the geographical location related information of the terminal to the IMS core.

In still another embodiment, the method may further comprise applying a call restriction and/or a policy control to the terminal based on the geographical location related information.

In yet another embodiment, the geographical location related information may comprise at least one of: a local IP address of the terminal, both the local IP address and a port number of the terminal, and a geographical location of the terminal derived from at least the local IP address.

In a sixth aspect of the present disclosure, an apparatus in a network node is provided. The apparatus comprises a processor and a memory, said memory containing instructions executable by said processor whereby said apparatus is operative to perform method according to any one of the first to the fifth aspects.

In a seventh aspect of the present disclosure, a computer program product is provided. The computer program product comprises instructions which, when executed on at least one processor, cause the at least one processor to carry out the method according to any one of the first to the fifth aspects.

In an eighth aspect of the present disclosure, an apparatus at a network node for facilitating location based service and/or policy control is provided, and the apparatus comprises processing means adapted to perform the method of any one of the first to the fifth aspects.

In an ninth aspect of the present disclosure, an apparatus in a first network node for facilitating location based services and/or location based policy control is provided, and the apparatus comprises: a first receiver configured to receive a message from a terminal connected to the first network node via non-3GPP access, the message comprising a local IP address or both the local IP address and a port number of the terminal; and a first transmitter, configured to send geographical location related information of the terminal to an IMS network via at least a network node for policy control function of the IMS network.

In one embodiment of the disclosure, the first receiver can be configured to receive the message from the terminal by receiving an authentication request message from the terminal during an attach procedure of the terminal.

In another embodiment of the disclosure, the apparatus may further comprise an obtaining module, configured to obtain a geographical location of the terminal based on at least the local IP address. In still another embodiment, the obtaining module may further comprise a second transmitter configured to transmit the local IP address or both the local IP address and the port number to a second network node, and a second receiver configured to receive from the second network node the geographical location derived from at least the local IP address.

In yet another embodiment, the first network node may be an ePDG, and the second network node may be an AAA server, and wherein the second transmitter is configured to transmit the local IP address or both the local IP address and the port number to the second network node by transmitting the local IP address or both the local IP address and the port number to the AAA server in a DER request message, and wherein the second receiver is configured to receive the geographical location derived from at least the local IP address by receiving the geographical location from the AAA server in a DER response message.

In still another embodiment, the first transmitter is configured to send geographical location related information of the terminal to the IMS network by sending the geographical location related information via a PGW to a PCRF during a PCC session creation or update procedure.

In a tenth aspect of the present disclosure, an apparatus in a second network node for facilitating location based services and/or location based policy control is provided, and the apparatus comprises: a receiver configured to receive a local IP address or both the local IP address and a port number of a terminal from a first network node to which the terminal is connected via non-3GPP access, a location deriving module configured to derive a geographical location of the terminal based on at least the local IP address; and a transmitter configured to transmit the derived geographical location to the first network node so as to enable the first network node to send the geographical location to an IMS network.

In one embodiment, the receiver may be configured to receive the local IP address or both the local IP address and a port number of the terminal from the first network node by receiving the local IP address or both the local IP address and the port number of the terminal from an ePDG in a DER request message, and wherein the transmitter may be configured to transmit the derived geographical location to the first network node by transmitting the geographical location to the ePDG in a DER response message.

In another embodiment, the location deriving module may be configured to derive a geographical location of the terminal based on at least the local IP address by translating the local IP address or both the local IP address and the port number to the geographical location through a database.

In a eleventh aspect of the present disclosure, an apparatus in a third network node for facilitating location based services and/or location based policy control is provided, and the apparatus comprises a receiver configured to receive a message from a first network node, the message comprising geographical location related information of a terminal connected to the first network node via non-3GPP access; and a transmitter configured to transmit the geographical location related information to an IMS network via at least a network node for policy control function of the IMS network.

In one embodiment of the disclosure, the receiver is configured to receive the message from the first network node by receiving a session creation request message from an ePDG.

In another embodiment, the transmitter is configured to transmit the geographical location related information to an IMS network by transmitting the geographical location related information to a PCRF during a PCC session creation or update procedure.

In a twelfth aspect of the present disclosure, an apparatus in a fourth network node for facilitating location based services and/or location based policy control is provided, and the apparatus comprises a first receiver configured to receive a message from a first network node, the message comprising geographical location related information of a terminal connected to the first network node via non-3GPP access; and a transmitter configured to transmit the geographical location related information of the terminal to an IMS network.

In one embodiment, the first receiver may be configured to receive a message from a first network node by receiving a PCC session creation or update message from a PGW.

In another embodiment of the disclosure, the transmitter may be configured to transmit the geographical location related information to the IMS network by transmitting the geographical location related information to the IMS network during an IMS registration or call procedure.

In yet another embodiment, the apparatus may further comprise a second receiver configured to receive an AAR message from a P-CSCF requesting user location information; and wherein the transmitter is configured to transmit the geographical location related information to an IMS network by transmitting an AAA message or a RAR message including the geographical location related information to the P-CSCF in response to the received AAR message.

In a thirteenth aspect of the present disclosure, an apparatus in a fifth network node for facilitating location based services and/or location based policy control is provided, and the apparatus comprises a first transmitter, configured to transmit a request to a first network node requesting user location information of a terminal accessed via non-3GPP access; a first receiver configured to receive geographical location related information of the terminal from the first network node in response to the request, and a second transmitter configured to transmit the geographical location related information of the terminal to an IMS core.

In one embodiment, the method may further comprise a second receiver, configured to receive a SIP REGISTER message from the terminal, and an access type checking module configured to determine the access type of the terminal based on the received SIP REGISTER message; and wherein the first transmitter is configured to transmit a request to a first network node by transmitting an AAR message to a PCRF requesting for the user location information of the terminal if the access type of the terminal is determined as non-3GPP access; and wherein the first receiver is configured to receive geographical location related information of the terminal from the first network node in response to the request by receiving the geographical location related information of the terminal from the PCRF in an AAA message or a RAR message.

In another embodiment, the second transmitter is configured to transmit the geographical location related information of the terminal to an IMS core by transmitting a SIP REGISTER message including the geographical location related information of the terminal.

In still another embodiment of the present disclosure, the method may further comprise a control module configured to apply at least one of a call restriction and a policy control to the terminal based on the geographical location related information.

It shall be appreciated that various embodiments of the first aspect may also be equally applied to the second, third, fourth and fifth aspect of the present disclosure.

According to one or more embodiments of the present disclosure, by means of communications with at least a network node for policy control function of the IMS network, geographical location related information of a terminal with non-3GPP access can be made available in the IMS network and thus location based services and/or location based policy control can be provided to the terminal.

### BRIEF DESCRIPTION OF THE DRAWINGS

The above and other aspects, features, and benefits of various embodiments of the present disclosure will become more fully apparent from the following detailed description with reference to the accompanying drawings, in which:

FIG. 1 shows an example communication system supporting 3GPP access and non-3GPP access;

FIG. 2 shows an example communication system where embodiments of the present disclosure may be implemented;

FIGS. 3a-3d illustrate flowcharts of a method at a first network node for facilitating location based services and/or location based policy control according to an embodiment of the present disclosure;

FIGS. 4a-4c illustrate example signalling diagrams showing signalling exchanges for facilitating location based services and/or location based policy control according to an embodiment of the present disclosure;

FIG. 5 illustrates a flowchart of a method at a second network node for facilitating location based services and/or location based policy control according to an embodiment of the present disclosure;

FIG. 6 illustrates a flowchart of a method at a third network node for facilitating location based services and/or location based policy control according to an embodiment of the present disclosure;

FIGS. 7a-7b illustrate flowcharts of a method at a fourth network node for facilitating location based services and/or location based policy control according to an embodiment of the present disclosure;

FIGS. 8a-8b illustrate flowcharts of a method at a fifth network node for facilitating location based services and/or location based policy control according to an embodiment of the present disclosure;

FIG. 9 illustrates a schematic block diagram of an apparatus adapted for facilitating location based services and/or location based policy control according to an embodiment of the present disclosure; and

FIG. 10 illustrates a schematic block diagram of an apparatus in a first network node for facilitating location based services and/or location based policy control according to an embodiment of the present disclosure;

FIG. 11 illustrates a schematic block diagram of an apparatus in a second network node for facilitating location based services and/or location based policy control according to an embodiment of the present disclosure;

FIG. 12 illustrates a schematic block diagram of an apparatus in a third network node for facilitating location based services and/or location based policy control according to an embodiment of the present disclosure;

FIG. 13 illustrates a schematic block diagram of an apparatus in a fourth network node for facilitating location based services and/or location based policy control according to an embodiment of the present disclosure; and

FIG. 14 illustrates a schematic block diagram of an apparatus in a fifth network node for facilitating location based services and/or location based policy control according to an embodiment of the present disclosure.

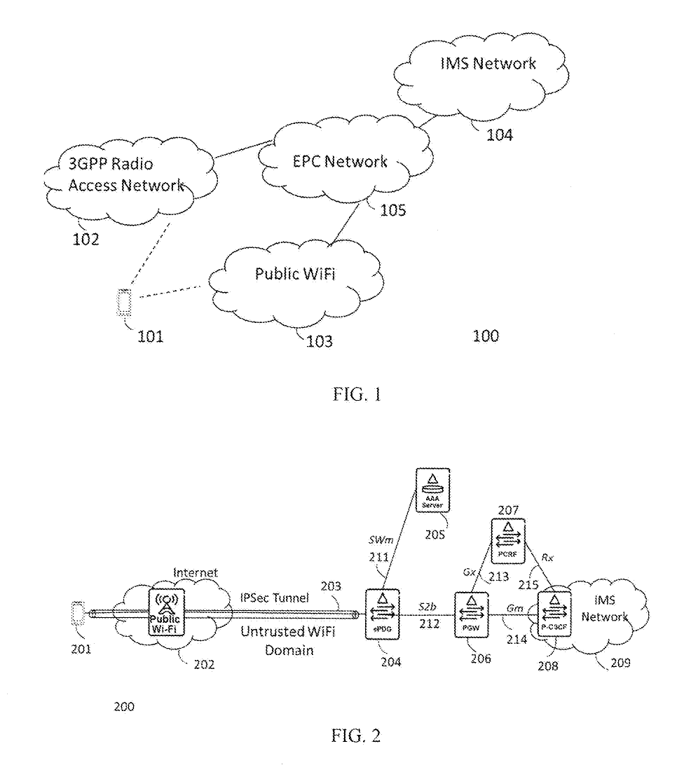

Like reference numbers and designations in the various drawings indicate like elements.

### DETAILED DESCRIPTION

Hereinafter, the principle and spirit of the present disclosure will be described with reference to illustrative embodiments. It should be understood, all these embodiments are given merely for one skilled in the art to better understand and further practice the present disclosure, but not for limiting the scope of the present disclosure. For example, features illustrated or described as part of one embodiment may be used with another embodiment to yield still a further embodiment. In the interest of clarity, not all features of an actual implementation are described in this specification.

References in the specification to “an embodiment,” “another embodiment,” “yet another embodiment,” etc. indicate that the embodiment described may include a particular feature, structure, or characteristic, but every embodiment may not necessarily include the particular feature, structure, or characteristic. Moreover, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that, although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. It can be appreciated that a first element in different embodiment may refer to different element. As used herein, the term “and/or” includes any and all combinations of one or more of the listed terms in association.

The terminology used herein is for the purpose of describing particular embodiments only and is not intended to limit the embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs. For example, the term “terminal” used herein may refer to any device capable of connecting to a wireless communication network via at least a non-3GPP access technique, for example IEEE 802. 11 untrusted Wi-Fi. The terminal can be, but not limited to, mobile phones, cellular phones, smart phones, or personal digital assistants (PDAs), portable computers, image capture devices such as digital cameras, gaming devices, music storage and playback appliances and any portable units or devices that have wireless communications capabilities, or Internet appliances permitting wireless Internet access and browsing and the like. In the disclosure, the terms “UE”, “device” and “terminal” may be used interchangeably.

For the purpose of illustration, the concept and principle of several embodiments of the present disclosure will be described in the context of a Wi-Fi access network. Those skilled in the art will appreciate, however, that the concept and principle of several embodiments of the present disclosure may be more generally applicable to other non-3GPP access scenarios.

FIG. 2 illustrates an example communication system 200 where embodiments of the present disclosure may be implemented. In the example communication system, a terminal 201 can access the internet via a non-3GPP access network, for example an IEEE 802. 11 public Wi-Fi network 202, and establish an IPsec tunnel 203 with the Evolved Packet Data Gateway (ePDG) 204. The IPsec tunnel 203 provides encrypted secure communication over an IP network. The ePDG 204 is a part of an Evolve Packet Core (EPC) which is a common core network supporting various access techniques, for example, 3GPP access and non-3GPP access. The ePDG 204 can further communicate with an Authentication, Authorization, and Accounting (AAA) server 205 and a Packet Data Network Gateway (PGW) 206 via a SWm interface 211 and a S2b interface 212 respectively. The AAA server 205 can determine, for example, which user can access a network server, which service can be provided to a specific user, and how to charge for network resources utilized by a user. The PGW 206 is also a part of the EPC and it can be further connected to another network node of the EPC, i.e., a Policy and Charging Rule Function (PCRF) 207 via a Gx interface 213 and also to a Proxy-Call Session Control Function (P-CSCF) 208 via a Gm interface 214, as shown in this figure. Both the PCRF 207 and the P-CSCF 208 can be considered as a part of a Policy and Charging Control (PCC) framework and they can communicate with each other via a Rx interface 215. Normal functions for the network nodes of the EPC, such as the ePDG, PGW, AAA server and the PCRF have been described in 3GPP specifications, for example in 3GPP TS 23.401 and 3GPP TS 23.402, and thus will not be detailed herein. The P-CSCF 208 is a network node located on the border of an IMS network 209, and descriptions for operations of a normal P-CSCF can be found, for example, in TS 23.228 and 3GPP TS 24.229 Release 12. It can be appreciated that the communication system 200 can also include other network elements not shown in FIG. 2, and some of the network nodes not necessary for implementing embodiments of the present disclosure have been omitted from FIG. 2 for clarity purpose.

Currently, there is no standard way for the IMS network side to obtain user location information for a device (e.g., device 201) with non-3GPP access, e.g., IEEE 802. 11 Wi-Fi access 202, and due to this, a lot of location based services and/or location based policy control cannot be applied for non-3GPP accessed device, e.g., for VoWiFi devices.

To facilitate location based services and/or location based policy control for devices with non-3GPP access, methods and apparatus are provided herein.

With embodiments of the disclosure, when the alternative 3GPP user location is not applicable, UE location information of a device can still be made available at the IMS by making use of a local IP address of the device provided by the device. For example, an UE Local IP address and a Port number (if network address translator (NAT) used) of an IPSec tunnel of the device can be utilized to obtain certain level of user location information and then the location information can be sent from an EPC to the IMS network. For example, the UE Local IP address may correspond to a public IP address of an access point (AP) for a specific deployment, and optionally, the UDP Port number can also be used as additional information when NAT is used. As another example, the UE Local IP address may implicitly indicate an IP range of a specific Internet service provider (ISP). Alternatively or additionally, the UE Local IP address may correspond to a specific region of a big country, such kind of location info can be used to add region code for an IMS voice call, for example, because an IP address (and port number) can be translated to a geographical location according to an embodiment of the disclosure.

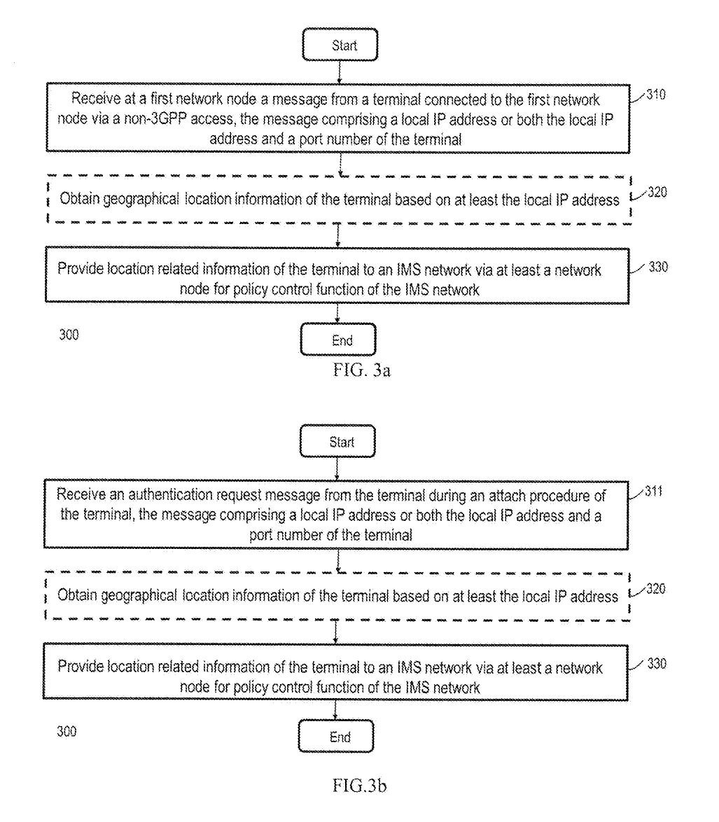

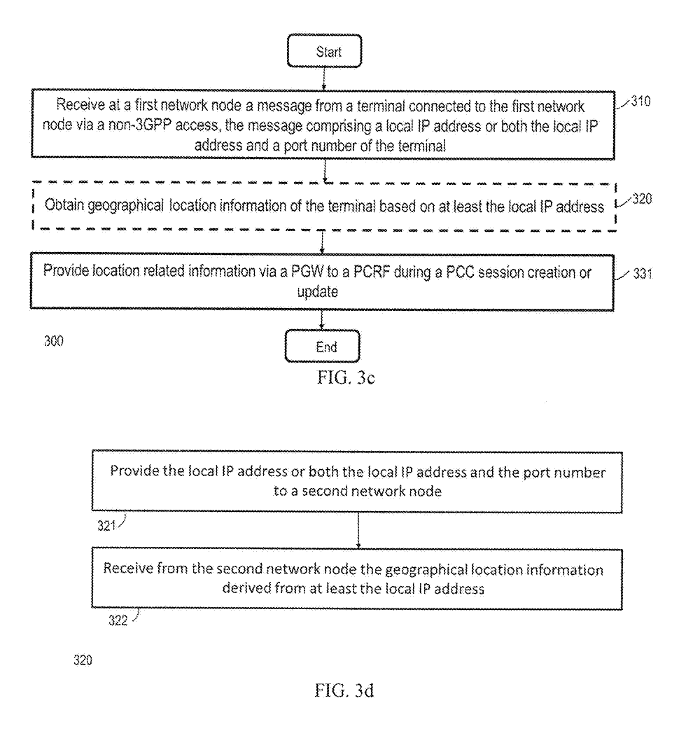

FIG. 3a illustrates a flowchart of an example method 300 for facilitating location based services and/or location based policy control for a terminal, for example the terminal 201 shown in FIG. 2, according to an embodiment of the present disclosure. The method 300 is performed at a first network node, for example but not limited to, the ePDG 204 shown in FIG. 2.

As illustrated in FIG. 3a, the method 300 enters at block 310, in which the first network node (e.g., the ePDG 204) receives a message from the terminal (e.g., UE 201 shown in FIG. 2). The terminal is connected to the first network node via a non-3GPP access network, for example an IEEE 802. 11 public Wi-Fi network 202. The received message includes at least a local IP address of the terminal. In one embodiment, the message may further include a port number, such as a User Datagram Protocol (UDP) port number of the terminal.

Block 311 shown in FIG. 3b provides an exemplary implementation of the block 310, where the first network node receives an authentication request message including at least the local IP address from the terminal during an attach procedure of the terminal. For example, the authentication request message from the terminal may be an Internet Key Exchange Protocol Version 2 (IKEv2) authentication request message specified in 3GPP standard. In this embodiment, the local IP address is the IP address used for setting up an IP sec tunnel, and the local IP address can be conveyed in a Header of the IKEv2 authentication request message. It allows reusing existing signalling in 3GPP and thus reducing impact to standardization. It can be appreciated that, in another embodiment, at block 310, the first network node may receive the message after the attach procedure. For example, the first network node may receive the message including the local IP address of the terminal in response to a request from the first network node to the terminal after an initial attach procedure.

Then at block 330, the first network node provides geographical location related information of the terminal to an IMS network (e.g., the IMS network 209 shown in FIG. 2) via at least a network node for policy control function of the IMS network. In one embodiment, the network node for policy control function of the IMS network may be a network node of a PCC framework. For example, the network node can be a PGW, and/or a PCRF and/or a P-CSCF.

Block 331 shown in FIG. 3c provides an example implementation of the block 330. At block 331, the first network node can provide the geographical location related information via a PGW (e.g., the PGW 206 shown in FIG. 2) to a PCRF (e.g., the PCRF 207 shown in FIG. 2) during a PCC session creation or update procedure, and the PCRF can send the geographical location related information to the IMS network (e.g., to the P-CSCF on the border of the IMS network).

The geographical location related information provided by the first network node to the IMS network via at least another network node at block 330 may comprise at least one of: the obtained geographical location, the local IP address, and both the local IP address and the port number. The exact content of the geographical location related information sent from the first network node may depend on system configuration/requirement and/or capability of the IMS network.

Optionally, in one embodiment, the method 300 may further comprise a block 320 as shown in FIG. 3a, where the first network node obtains a geographical location of the terminal based on at least the local IP address prior to providing the geographical location related information of the terminal to the IMS network. It can be appreciated that in an embodiment where the first network node only provides the local IP address, or both the local IP address and the port number to the IMS network at block 330, the operation of block 320 can be omitted.

In another embodiment, at block 320, the first network node may translate the received local IP address or both the local IP address and the port number to the geographical location by using, for example, a database, a look-up table, or a network address translator, etc. Then the geographical location can be provided to the IMS network at block 330 in any proper format and/or with any proper granularity. It can be appreciated that the geographical location can be provided to the IMS network separately or together with the local IP address and/or the port number.

Alternatively, in still another embodiment, the first network node may obtain the geographical location from another network node. One example is shown in FIG. 3d, wherein the first network node transmits/provides the local IP address or both the local IP address and the port number to a second network node, for example the AAA server 205 shown in FIG. 2, at block 321; and at block 322, the first network nodes receives from the second network node the geographical location derived from at least the local IP address. In this example, the second network node is responsible for translating the local IP address or both the local IP address and the port number to corresponding geographical location by using, for example, a database, a look-up table, or a network address translator, etc. The database can be a local GeoIP DataBase (DB) which stores a mapping between a local IP address (and optionally a port number) and corresponding geographical location. The geographical location may include at least one of: a country code, a state code, a city code, a street code, etc. of the terminal. The GeoIP DB may locate at the AAA server 205, or locate at another network node not shown in FIG. 2. In the latter case, the AAA server 205 may communicate with the other network node not shown to obtain the geographical location.

It can be appreciated by those skilled in the art that embodiments of the present disclosure are not limited to any particular signalling/message for transmitting/providing the local IP address information at block 321 or for receiving the derived geographical location at block 322.

Just as one example, at block 321, the first network node may transmit the local IP address or both the local IP address and the port number to the AAA server in a Diameter-EAP-Request (DER) request message, and at block 322, the first network node may receive the geographical location from the AAA server in a DER response message. In this embodiment, the first network node can obtain the geographical location by reusing existing 3GPP signalling. For example, the existing DER Response message defined in 3GPP can be modified to include a field of “UE Geographic location info” which indicates the derived geographical location. It can be appreciated that other existing fields (e.g., key and Access Point Name (APN)) of the DER Response message can be kept unchanged.

In another embodiment, at block 321 and/or block 322, the first network node can communicate with the second network node via a new message dedicated for indicating the location information.

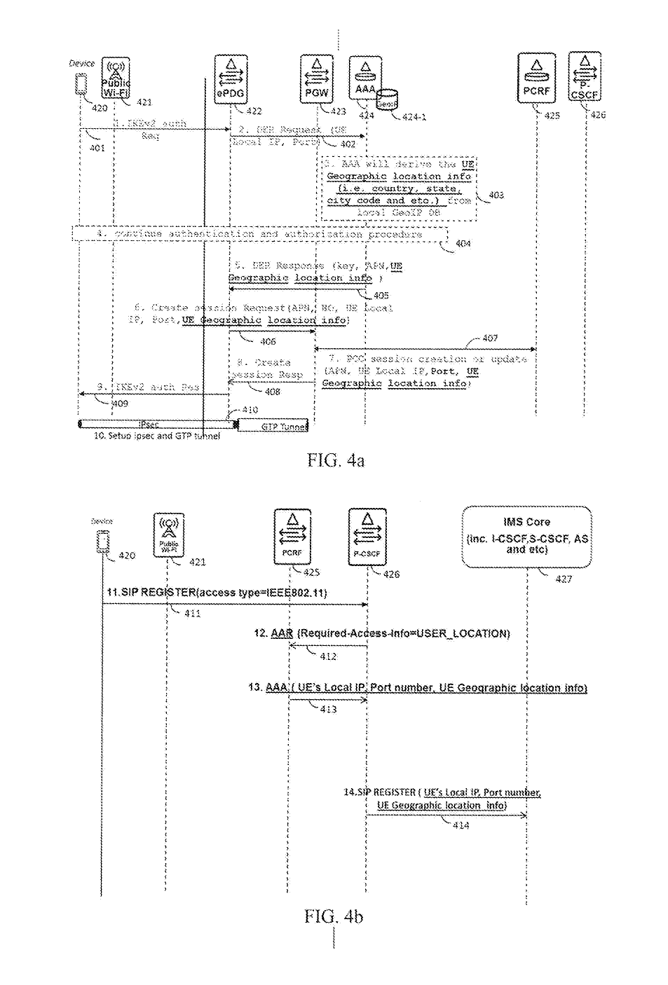

FIG. 4a illustrates an example of signalling exchanges among network nodes during a UE attach procedure for providing user location information to an IMS network to facilitate location based services and/or location based policy control according to an embodiment of the present disclosure.

As shown, at 401, a device 420 which has accessed via non-3GPP access (e.g., public Wi-Fi access) 421 initiates an IKEv2 tunnel establishment procedure by sending an IKEv2 authentication request to an ePDG 422. The ePDG 422 can be the first network node described with reference to the method 300. The IKEv2 tunnel establishment can be due to initial attach or LTE to Wi-Fi handover on S2b, for example. At the ePDG 422 side, corresponding receiving operation as described with reference to block 310 or 311 of method 300 can be performed.

At 402, the ePDG 422 sends a Diameter-EAP-Request (DER) request to an AAA server 424. The AAA server 424 can be the second network node described with reference to blocks 321 and 322 of FIG. 3d. The DER request message may include local IP address and optionally a port number for the device 420.

Both the IKEv2 authentication request message and the DER message can reuse existing signalling specified in 3GPP (e.g., 3GPP TS 24.303 and 3GPP TS 29.273), that is, the operations 401 and 402 may not require change to existing signalling, the terminal 420 and the ePDG 422.

At 403, the AAA server 424 may derive geographical location based on the local IP address obtained in the received DER request message, or based on both the local IP address and the port number. The AAA server 424 may derive the geographical location through a local GeoIP DataBase (DB) 424-1 which stores a mapping between a local IP address (and optionally a port number) and corresponding geographical location. The GeoIP DB 424-1 may locate at the AAA server 424, or another network node not shown. In the latter case, the AAA server 424 may derive geographical location by communicating with the other network node not shown. The geographical location may include information about at least one of country code, state code, city code, street code, etc. of the device. Since this geographical information is derived from the local IP address provided by the user, the geographical information is also referred as user provided location information hereafter.

At 405, the AAA server 424 can return the derived location information to the ePDG 422 by sending a DER Response message, in one embodiment. In this embodiment, the derived user location information can be included into the DER Response message as a new field, for example “UE Geographic location info” field, while keeping other existing fields of the DER response message unchanged. In still another embodiment, the AAA server 424 may return the derived user location information by sending a new message rather than modifying and reusing an existing message. At the ePDG 422 side, corresponding receiving operation as described with reference to block 322 of FIG. 3d can be performed.

In another embodiment, optionally, before the operation of 405, authentication and authorization procedure can be performed at 404.

In one embodiment, at 406, the ePDG 422 further sends the derived user location information together with the Local IP address and Port number of the terminal over S2b interface to a PGW 423. In one example embodiment, the location information may be sent to the PGW 423 during a PCC session creation or update procedure. For example, the ePDG 422 may send the location information in a Create session Request message by adding a new field (e.g., UE Geographic location info) to this message and keep other existing fields unchanged. This is an example of the operation performed in blocks 330 or 331 described with reference to FIGS. 3a and 3c.

In another embodiment, the ePDG 422 may only send the derived location information (i.e., geographical location), or, the Local IP address and Port number of the terminal to the PGW 423. Exact geographical location related information sent from the ePDG to the PGW may depend on system configuration/requirement, and/or, capability of the involved IMS network.

It can be appreciated that the ePDG 422 may send the geographical location related information in a new message rather than reusing the existing Create session Request message in another embodiment.

After receiving the geographical location related information provided by the ePDG at 406, the PGW 423 can send the geographical location related information to the IMS network via a PCC framework. For example, at 407, the PGW can send the geographical location related information (i.e., at least one of the derived geographical location, the local IP address, and both the local IP address and the Port number of the device 420) to a PCRF 425 over a Gx interface. In one embodiment, the PGW 423 may send the geographical location related information to the PCRF during a PCC session creation or update (e.g., due to LTE to Wi-Fi handover) procedure. For example, the PGW may send a PCC Session Creation message or a PCC Session Update message to the PCRF to create or update the PCC session, and the PCC Session Creation message or a PCC Session Update message is modified to also include the geographical location related information, such as UE Local IP address, and/or Port number, and/or UE Geographic location info.

In case the PGW sends the geographical location related information to the PCRF during a session creation procedure at 407, normal session creation procedure can continue at 408-410. For example, the PGW 423 can send a Create Session Response message to the ePDG 422 at 408, and the ePDG 422 then send a final IKEv2 message (i.e., an IKEv2 authentication Response message) to device 420 at 409, and then at 410, IP connectivity (i.e., the IPsec tunnel and the GTP tunnel) from the UE to the PGW is setup.

The availability of the geographical location related information at the PCRF 425 enables the PCRF 425 to transmit the geographical location related information to the IMS network, e.g., the P-CSCF 426 via an Rx interface 215 as shown in FIG. 2. For example, the PCRF can transmit the geographical location related information to the P-CSCF during an IMS registration or call procedure.

FIG. 4b illustrates an example of signaling exchanges during an IMS registration procedure according to an embodiment of the present disclosure. As shown in FIG. 4b, at 411, the device 420 accessed via an IEEE 802. 11 network can initiate a SIP Registration procedure by sending a SIP REGISTER message to the P-CSCF 426. Optionally, the SIP REGISTER message (411) may include a field of “access type” which indicates the radio communication technology/standard used by the device for access. In this example, the “access type” can be set to “IEEE 802.11”.

At the P-CSCF 426 side, it performs the corresponding receiving operation of the SIP REGISTER message. In one embodiment, optionally, the P-CSCF can check the “access type” field included in the SIP REGISTER message, and if “access type” indicates a non-3GPP access type, for example, IEEE 802.11, the P-CSCF may request the user location information from the PCRF 425 by sending an Authentication Authorization-Request (also referred to as AA-Request, or AAR) message, to the PCRF at 412. In the AAR message, the P-CSCF can indicate that the requested user access information is the user location information. In another embodiment, the P-CSCF may request the user location information from the PCRF 425 by sending the AAR message to the PCRF at 412 after receiving the SIP REGISTER message, without checking the access type. That is, in this embodiment, the P-CSCF may request the user location information from the PCRF 425 regardless of the access type used by the device.

In response to the received AAR message, at 413, the PCRF 425 can return an Authentication Authorization-Answer (also referred to as AA-Answer, or AAA) message to the P-CSCF 426. The P-CSCF 426 locates at the border of the IMS network, as shown in FIG. 2. The AAA message comprises the geographical location related information, i.e., at least one of: the geographical location of the device 420, local IP address of the device 420, and both the local IP address and port number of the device 420.

Then the P-CSCF 426 may further send the geographical location related information to the IMS core 427 at 414, for example by sending a SIP REGISTER message. The geographical location related information may be included in the SIP REGISTER message as a part of a new SIP header, or a part of an existing SIP header PANI/PVNI.

FIG. 4c shows another example of signaling exchanges during an IMS registration procedure according to another embodiment of the present disclosure. Similar as that shown in FIG. 4b, in this example, the device 420 can initiate a SIP Registration procedure by sending a SIP REGISTER message to the P-CSCF 426 at 411. Optionally, upon receiving the SIP REGISTER message, the P-CSCF can check “access type” field of the message. If “access type” indicates a non-3GPP access type, for example, IEEE 802.11, the P-CSCF may request the user location information from the PCRF by sending an AAR message to the PCRF at 412. It can be appreciated that the P-CSCF may also send the AAR message to the PCRF regardless of the access type used by the device in another embodiment. In the example shown in FIG. 4c, the PCRF can return an AAA message at 413, however, this AAA message may be a normal AAA message without the user location information included, and it may only serve as an acknowledgement to the AAR message. Alternatively, the PCRF 425 can include the geographical location related information in a Re-authentication Request (RAR) message and send the RAR message to the P-CSCF 426 at 415. The geographical location related information may be inserted into an existing Attribute Value Pair (AVP) or new AVP of the RAR message. Then the P-CSCF can respond with a Re-authentication Answer (RAA) message at 416. Then, the P-CSCF 426 may send the geographical location related information to the IMS core 427 at 414, for example by sending a SIP REGISTER message, with the geographical location related information included as a part of a new SIP header, or a part of an existing SIP header PANI/PVNI.

In both examples of FIGS. 4b and 4c, the IMS core is enabled to offer location based services and/or policy control based on the received geographical location related information or part of it after receiving the geographical location related information. For example, the user geographical location info and/or IP range may be utilized by at least one of an Interrogating Call Session Control Function (I-CSCF), a Serving Call Session Control Function (S-CSCF), and/or an Application Server (AS) of the IMS core to offer location based services or policy control to the device depending on operator's configuration. It can be appreciated that in another embodiment, the geographical location related information of the device may be utilized by another network node of the IMS core which is not shown in the figure.

Alternatively or additionally, the P-CSCF 426 may apply some call restriction and/or other policy control based on part or all of the geographical location related information depending on operator's configuration, before or after sending the geographical location related information to the IMS core (414). In one embodiment, the P-CSCF 426 may utilize the geographical location related information to apply call restriction and/or other policy control to the device, without sending the geographical location related information to the IMS core.

Though FIG. 4b and FIG. 4c provide examples of signaling during a SIP registration procedure, it can be appreciated that the geographical location related information can also be transmitted from the PCRF 425 to the P-CSCF 426 after the SIP registration. For example, the PCRF can send the geographical location related information to the P-CSCF during a normal SIP call. In one embodiment, the P-CSCF can retrieve the geographical location related information (at least one of: the UE Local IP address, UDP Port number, and user geographical location) from the PCRF if this is required by the operator.

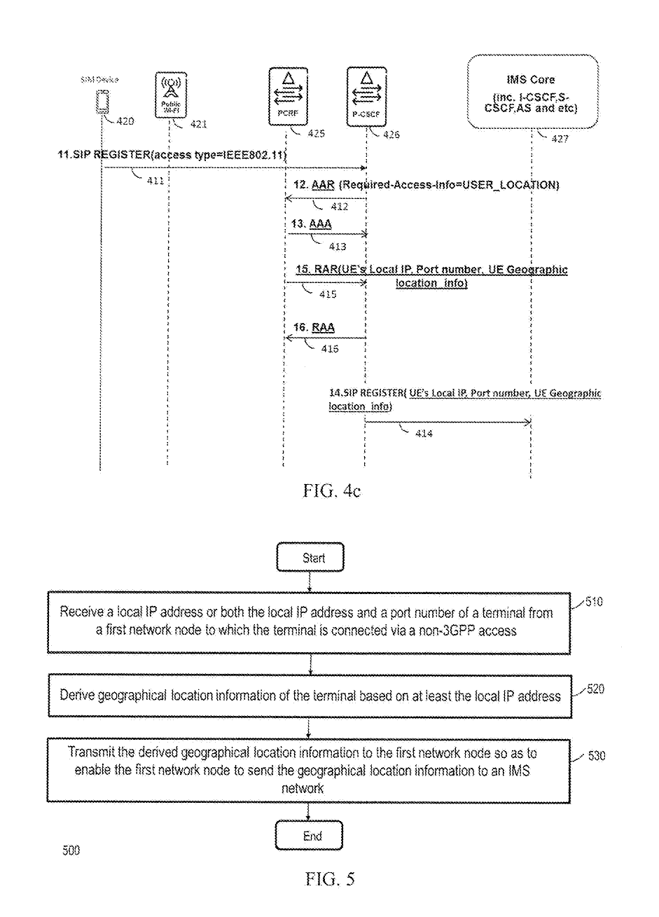

FIG. 5 illustrates a flowchart of an example method 500 for facilitating location based services and/or location based policy control for a terminal, for example the terminal 201 or 420 shown in FIGS. 2 and 4a-4c, according to an embodiment of the present disclosure. The method 500 can be performed by a second network node, for example but not limited to, the AAA server 205 shown in FIG. 2 or the AAA server 424 shown in FIG. 4a.

As shown, the method enters at block 510, where the second network node (e.g., the AAA server 424) receives a local IP address or both the local IP address and a port number of a terminal (e.g., the terminal 201 in FIG. 2 or the device 420 in FIG. 4a) from a first network node (e.g., the ePDG 422 shown in FIG. 4a) to which the terminal is connected via non-3GPP access (e.g., IEEE 802. 11 public Wi-Fi). In one embodiment, at block 510, the second network node may receive the local IP address or both the local IP address and the port number from the ePDG 422 in a DER request message as shown by the signaling 402 in FIG. 4a. In this embodiment, the existing DER request message may be reused without any change. It can be appreciated by those skilled in the art that embodiments of the present disclosure are not limited to any particular signaling for transmitting the local IP address information. For example, at block 510, the AAA server may also receive the local IP address though a new message.

At block 520, the second network node derives a geographical location of the terminal based on at least the local IP address. For example, the second network node can be the AAA server 424 and it may derive the geographical location through a database, or a network address translator, or a look-up table. For example, the AAA server may translate the local IP address or both the local IP address and the port number to the geographical location through a database, as described with reference to the operation 403 in FIG. 4a, and thus details will not be repeated here.

Then at block 530, the second network node transmits the derived geographical location to the first network node (e.g., the ePDG 422) so as to enable the first network node to send the geographical location to an IMS network. The derived geographical location transmitted by the second network node at block 530 can be same as that received by the first network node at block 320 which has been described with reference to method 300, and therefore, the description on the geographical location with reference to method 300 also apply here.

In one embodiment, the second network node may transmit the geographical location to the first network node by sending a DER response message. The transmission of the DER response message 405 has been described with reference to FIG. 4a, and details will not be repeated here.

It can be appreciated that embodiments are not limited to any exact message for sending the geographical location, instead, any suitable messages can be used for transmitting the geographical location at block 530.

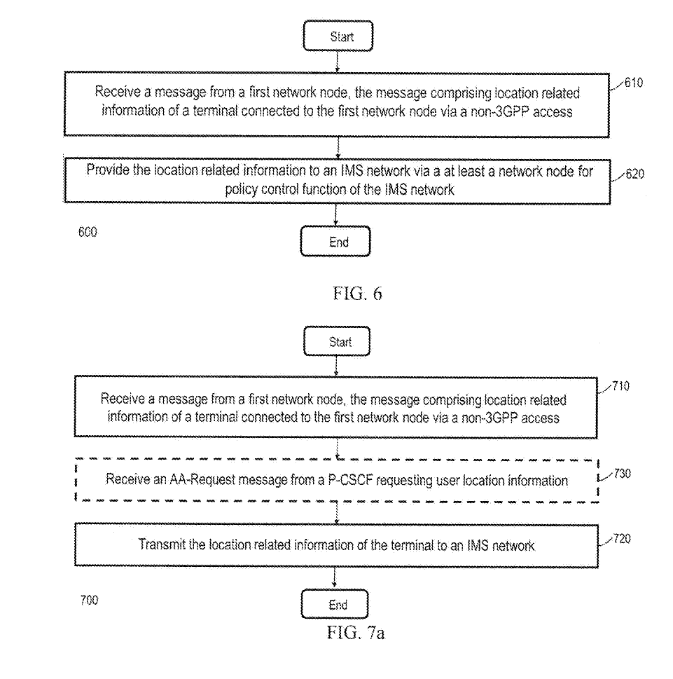

FIG. 6 illustrates a flowchart of an example method 600 for facilitating location based services and/or location based policy control for a terminal, for example the terminal 201 or 420 shown in FIGS. 2 and 4a-4c, according to an embodiment of the present disclosure. The method 600 can be performed by a third network node, for example but not limited to, the PGW 206 shown in FIG. 2 or 423 shown in FIG. 4a.

As shown, the method enters at block 610, where the third network node (e.g., the PGW 423) receives a message from a first network node (e.g., the ePDG 204 in FIG. 2 or 422 in FIG. 4), the message comprising geographical location related information of a terminal connected to the first network node via non-3GPP access (e.g., IEEE 802. 11 public Wi-Fi access); and at block 620, the third network node provides the geographical location related information to an IMS network via at least a network node for policy control function of the IMS network.

The geographical location related information received at block 610 can be same as that transmitted by the first network node at block 330 or 331 of method 300. For example, the located related information may comprise at least one of: a local IP address of the terminal, both the local IP address and a port number of the terminal, and a geographical location of the terminal derived from at least the local IP address.

In one embodiment, at block 610, the PGW 423 may receive the geographical location related information by receiving a session creation request message from the ePDG 422, as described with reference to the signaling 406 in FIG. 4a. For example, the geographical location may be included in the session creation request message as a field of “UE Geographic location info”. Alternatively or additionally, the local IP address of the terminal may be included as a “UE Local IP” field. Optionally, the message may also include information on Port number. As can be appreciated, other existing field (e.g., APN) of the session creation request message may be kept unchanged.

In another embodiment, at block 610, the PGW 423 may receive the geographical location related information by receiving a new message, and the new message may be received during a session creation procedure or after the session creation procedure.

In one embodiment, at block 620, the PGW 423 may transmit the geographical location related information to a PCRF (e.g., the PCRF 425 shown in FIGS. 4a-4c), for example, during a PCC session creation or update procedure. For example, as shown in 407 of FIG. 4a, the PGW 423 may include the geographical location as a field of “UE Geographic location info”. Alternatively or additionally, the PGW 423 may include the local IP address and port number of the terminal as a field of “UE Local IP” and “port” respectively. Other existing fields of the session creation or update message, such as APN can be kept unchanged.

It can be appreciated that the PGW 423 may also transmit the geographical location related information to the PCRF after the session creation or update procedure, in another embodiment, and the geographical location related information may be included into any suitable message.

After that, the PCRF can send the geographical location related information to the IMS through any suitable message.

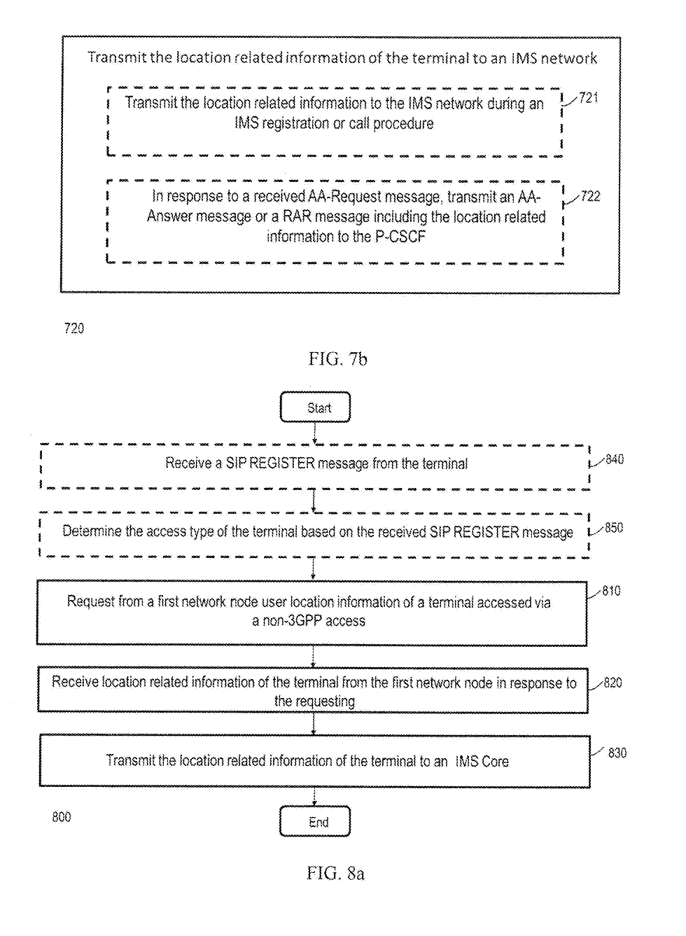

FIG. 7a illustrates a flowchart of an example method 700 for facilitating location based services and/or location based policy control for a terminal, for example the terminal 201 or 420 shown in FIGS. 2 and 4a-4c, according to an embodiment of the present disclosure. The method 700 can be performed by a fourth network node, for example but not limited to, the PCRF 207 shown in FIG. 2 or the PCRF 425 shown in FIGS. 4a-4c.

As shown, at block 710, the fourth network node (e.g., the PCRF 425) receives a message from another network node (e.g., the PGW 423 shown in FIG. 4a), the message comprising geographical location related information of the terminal connected to the first network node via non-3GPP access (e.g., IEEE 802. 11 Wi-Fi network). In one embodiment, at block 710, the PCRF 425 may receive a PCC session creation or PCC session update message from the PGW 423, as shown by the signaling 407 in FIG. 4a. In another embodiment, the message received at block 710 can be same as that transmitted by the third network node at block 620 of method 600, and therefore, details of the message described with reference to method 600 are also applicable here.

As shown in FIG. 7a, at block 720, the fourth network node transmits the geographical location related information of the terminal to an IMS network. In one embodiment, the transmission at block 720 may occur during an IMS registration procedure, as shown in block 721 of FIG. 7b. In another embodiment illustrated in FIG. 7b, the transmission of the geographical location related information at block 720 may happen during a call procedure.

Optionally, the method 700 may further comprise a block 730, where the fourth network node receives an Authentication Authorization-Request (AAR) message from a P-CSCF 426. The AAR message indicates a request for geographical location related information. Signaling 412 in FIGS. 4b-4c provides an example for the AAR message from a P-CSCF to a PCRF 425. In this example, the PCRF can transmit the geographical location related information to the IMS network by transmitting an Authentication Authorization-Answer (AAA) message to the P-CSCF, in response to the received AAR message, as shown in block 722 of FIG. 7b. This AAA message has been described with reference to signaling 413 in FIG. 4b, and the description also applies here and thus will not be repeated.

Alternatively, in another embodiment, the PCRF 425 can also transmit the geographical location related information to the IMS network by transmitting a Re-authentication Request (RAR) message to the P-CSCF 426, as shown in FIG. 7b and FIG. 4c. The geographical location related information comprises at least one of: a local IP address of the terminal, both the local IP address and a port number of the terminal, and geographical location of the terminal derived from at least the local IP address.

It can be appreciated that though example messages have been provided for conveying the geographical location related information, embodiments of the present disclosure are not limited to any particular message, or in other words, the geographical location related information can be sent to the IMS network using any new message or any existing message.

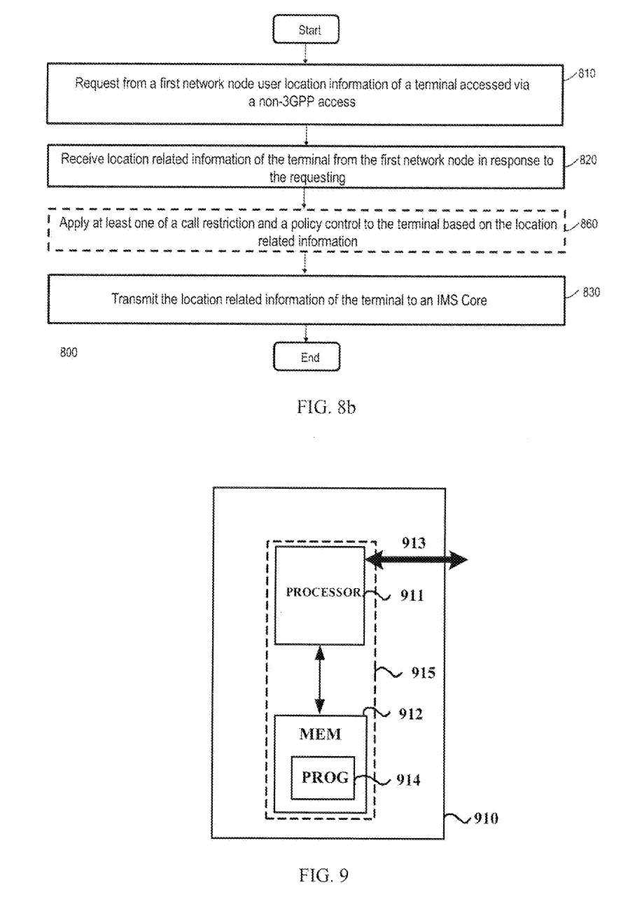

FIG. 8 illustrates a flowchart of an example method 800 for facilitating location based services and/or location based policy control for a terminal, for example the terminal 201 or 420 shown in FIGS. 2 and 4a-4c, according to an embodiment of the present disclosure. The method 800 can be performed by a fifth network node, for example but not limited to, the P-CSCF 208 shown in FIG. 2 or the P-CSCF 426 shown in FIGS. 4a-4c.

As shown in FIGS. 8a and 8b, at block 810, the fifth network node (e.g., the P-CSCF 426) transmits a request to another network node (e.g., the PCRF 425 shown in FIGS. 4a-4c) requesting geographical location related information of a terminal accessed via non-3GPP access (e.g., public Wi-Fi access network); then at block 820, the fifth network node receives geographical location related information of the terminal from the another network node in response to the request; and at block 830, the fifth network node transmits the geographical location related information of the terminal to an IMS core. As shown in FIGS. 4b-4c, an IMS core may include a S-CSCF, an I-CSCF, an AS, etc.

In one embodiment, at block 810, the fifth network node may request geographical location related information of the terminal from a PCRF (e.g., the PCRF 425 in FIGS. 4a-4c) by transmitting to it an AA-Request (AAR) message, the message including the request for the geographical location related information.

Optionally, as shown in FIG. 8a, the method 800 may further comprise a block 840, where the fifth network node receives a Session Initiation Protocol (SIP) REGISTER message from the terminal, and a block 850, where the fifth network node determines the access type of the terminal based on the received SIP REGISTER message. In this embodiment, at block 810, the fifth network node may request geographical location related information of the terminal from the another network node (e.g., the PCRF 425 in FIGS. 4a-4c) if the access type of the terminal is determined as non-3GPP access (e.g., IEEE 802.11). Signaling 411 shown in FIGS. 4b-4c provides an example for the SIP REGISTER message received at block 840, and signaling 412 can be considered as an example for the request transmitted at block 810. It can be appreciated, however, the fifth network node (e.g., the P-CSCF 426) may also request geographical location related information of the device from the another network node regardless of the access type of the device, in another embodiment.

In one embodiment, at block 820, the fifth network node can receive from a PCRF an Authentication Authorization-Answer (also referred to AA-Answer or AAA) message including the geographical location related information of the terminal. Signaling 413 shown in FIG. 4b provides an example for the AAA message received by the fifth network node at block 820.

Alternatively, in one embodiment, at block 820, the fifth network node can receive from a PCRF a Re-authentication Request (RAR) message including the geographical location related information of the terminal. Signaling 415 shown in FIG. 4c provides an example for the RAR message received by the fifth network node at block 820.

Likewise, in one embodiment, at block 830, the fifth network node may transmit the geographical location related information of the terminal to the IMS core via a SIP REGISTER message, as shown by the signaling 414 in FIGS. 4b-4c. That is, the SIP REGISTER message includes the geographical location related information of the terminal. The geographical location related information may comprise at least one of: a local IP address of the terminal, both the local IP address and a port number of the terminal, and a geographical location of the terminal derived from at least the local IP address

It can be appreciated that the example messages are provided just for illustration rather than limitation, and actually any suitable messaged can be used for transmitting/receiving at each block shown in FIG. 8a. For example the transmitting/receiving can use a new message or reuse an existing message by adding new fields. In one embodiment, the SIP message received in block 840 of FIG. 8a could be another SIP message e.g., an INVITE, or a Re-INVITE message, instead of the SIP REGISTER message.

Alternatively or additionally, in one embodiment shown in FIG. 8b, the method 800 may further comprise block 860, where the fifth network node (e.g., the P-CSCF 208 shown in FIG. 2 or P-CSCF 426 shown in FIG. 4a-4c) applies a call restriction and/or a policy control to the terminal based on the geographical location related information. It can be appreciated that the call restriction and/or the policy control may be applied before or after the operation of block 830. In another embodiment, the P-CSCF 426 may also apply the call restriction and/or the policy control based on the geographical location related information without sending the geographical location related information to the IMS core.

FIG. 9 illustrates a schematic block diagram of an apparatus 910 adapted for facilitating location based services and/or location based policy control according to an embodiment of the present disclosure. The apparatus 910 may be embodied at or as at least part of a network node, for example but not limited to, an ePDG, an AAA server, a PGW, a PCRF or a P-CSCF.

The apparatus 910 comprises at least one processor 911, such as a data processor (DP) and at least one memory (MEM) 912 coupled to the processor 911. The apparatus 910 may further comprise a transmitting and receiving interface 913 coupled to the processor 911 for establishing communications with other network nodes or devices. The MEM 912 stores a program (PROG) 914. The PROG 914 may include instructions that, when executed on the associated processor 911, enable the apparatus 910 to operate in accordance with the embodiments of the present disclosure, for example to perform the method 300, 500, 600, 700 or 800. A combination of the at least one processor 911 and the at least one MEM 912 may form processing means 915 adapted to implement some embodiments of the present disclosure.

The MEM 912 may be of any type suitable to the local technical environment and may be implemented using any suitable data storage technology, such as semiconductor based memory devices, magnetic memory devices and systems, optical memory devices and systems, fixed memory and removable memory, as non-limiting examples.

The processors 911 may be of any type suitable to the local technical environment, and may include one or more of general purpose computers, special purpose computers, microprocessors, digital signal processors DSPs and processors based on multicore processor architecture, as non-limiting examples.

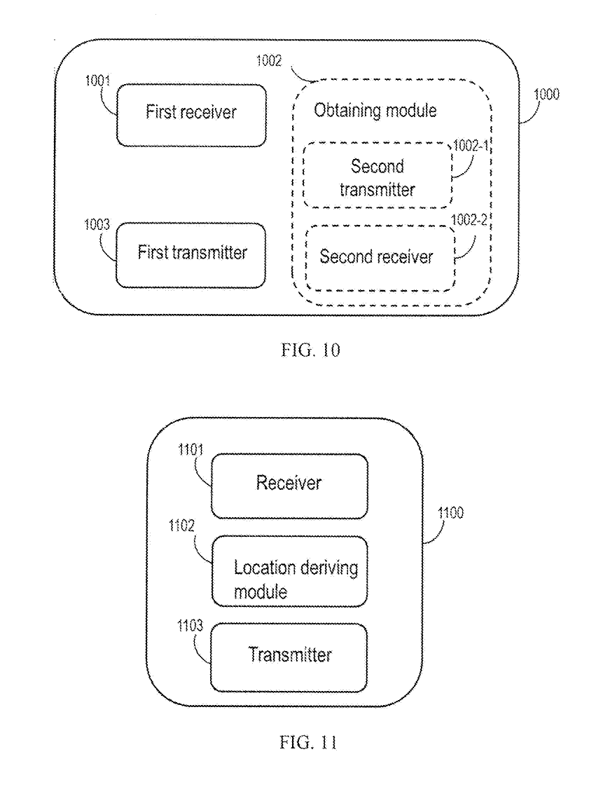

FIG. 10 illustrates a schematic block diagram of an apparatus 1000 adapted for facilitating location based services and/or location based policy control according to an embodiment of the present disclosure. The apparatus 1000 may be embodied at or as at least part of a first network node, for example but not limited to an ePDG 422 shown in FIG. 4a.

In FIG. 10, units in blocks with a solid line are essential while units in blocks with a broken line are optional depending on various implementations of the present disclosure.

Particularly, as illustrated in FIG. 10, the apparatus 1000 comprises a first receiver 1001, and a first transmitter 1003. The first receiver 1001 is configured to receive a message from a terminal connected to the first network node via non-3GPP access, the message comprising a local IP address or both the local IP address and a port number of the terminal. In one embodiment, the local IP address and the port number can be an IP address and an UDP port number used for establishing an IPsec tunnel. In another embodiment, the non-3GPP access can be IEEE 802.11 public Wi-Fi access. The first transmitter 1003 is configured to provide geographical location related information of the terminal to an IMS network via at least a network node for policy control function of the IMS network.

In an embodiment, the first receiver 1001 can be configured to receive the message from the terminal by receiving an authentication request message, for example an IKEv2 authentication request message, from the terminal during an attach procedure of the terminal. In this case, the local IP address or both the local IP address and the port number of the terminal can be included in a Header of the message. It can be appreciated that in another embodiment, the first receiver 1001 may be configured to receive the local IP address or both the local IP address and the port number of the terminal in another message after the attach procedure.

Preferably, in one embodiment, the first transmitter 1003 may be configured to provide the geographical location related information of the terminal to the IMS network by providing the geographical location related information via a PGW to a PCRF during a PCC session creation or update procedure. The PCRF can send the geographical location related information to the IMS network.

In one embodiment, the geographical location related information of the terminal may comprise the obtained geographical location. In another embodiment, the geographical location related information may comprise the local IP address or both the local IP address and the port number. In still another embodiment, the geographical location related information may comprise the geographical location, the local IP address and the port number of the terminal.

Optionally, in another embodiment, the apparatus 100 may further comprise an obtaining module 1002 as shown in FIG. 10. The obtaining module 1002 can be configured to obtain a geographical location of the terminal based on at least the local IP address before the first transmitter 1003 providing the geographical location related information of the terminal to the IMS network. It can be appreciated that in an embodiment where the first transmitter 1003 is only configured to provide the local IP address, or both the local IP address and the port number to the IMS network, the obtaining module 1002 can be removed from the apparatus 1000.

In another embodiment, the obtaining module 1002 may further comprise a second transmitter 1002-1 and a second receiver 1002-2. The second transmitter 1002-1 is configured to transmit the local IP address or both the local IP address and the port number to a second network node (e.g., an AAA server), and the a second receiver 1002-2 is configured to receive from the second network node the geographical location derived from at least the local IP address. In a further embodiment, the second transmitter 1002-1 can be configured to transmit the local IP address or both the local IP address and the port number to an AAA server in a DER request message, and the second receiver 1002-2 can be configured to receive the geographical location from the AAA server in a DER response message. Then the received geographical location can be provided by the first transmitter 1003 to the IMS network, for example, together with the local IP address, or without the local IP address.

The above blocks 1001, 1002, and 1003 may be configured to implement corresponding operations or steps and to achieve corresponding technical effects as described with reference to method 300 and FIGS. 3a-3d, and thus details will not be repeated herein for the purpose of succinctness.

FIG. 11 illustrates a schematic block diagram of an apparatus 1100 adapted for facilitating location based services and/or location based policy control according to an embodiment of the present disclosure. The apparatus 1100 may be embodied at or as at least part of a second network node, for example but not limited to an AAA server 424 shown in FIG. 4a.

Particularly, as illustrated in FIG. 11, the apparatus 1100 comprises a receiver 1101, a location deriving module 1102 and a transmitter 1103. The receiver 1101 is configured to receive a local IP address or both the local IP address and a port number of a terminal from a first network node to which the terminal is connected via non-3GPP access (e.g., an IEEE 802.11 public Wi-Fi access network). For example, the first network node can be an ePDG. The location deriving module 1102 is configured to derive a geographical location of the terminal based on at least the local IP address. In one embodiment, the location deriving module 1102 may be configured to translate the local IP address or both the local IP address and the port number to the geographical location through a database, e.g., a GeoIP database located at the apparatus 1100. In one embodiment, the database may locate inside of the location deriving module 1102. The transmitter 1103 is configured to transmit the derived geographical location to the first network node so as to enable the first network node to send the geographical location to an IIMS network.

In one embodiment, the receiver 1101 can be configured to receive the local IP address or both the local IP address and the port number from an ePDG in a DER request message and the transmitter 1103 is configured to transmit the derived geographical location to the ePDG in a DER response message.

The above units 1101, 1102, and 1103 may be configured to implement corresponding operations or steps and to achieve corresponding technical effects as described with reference to method 500 and FIG. 5, and thus details will not be repeated herein for the purpose of succinctness.

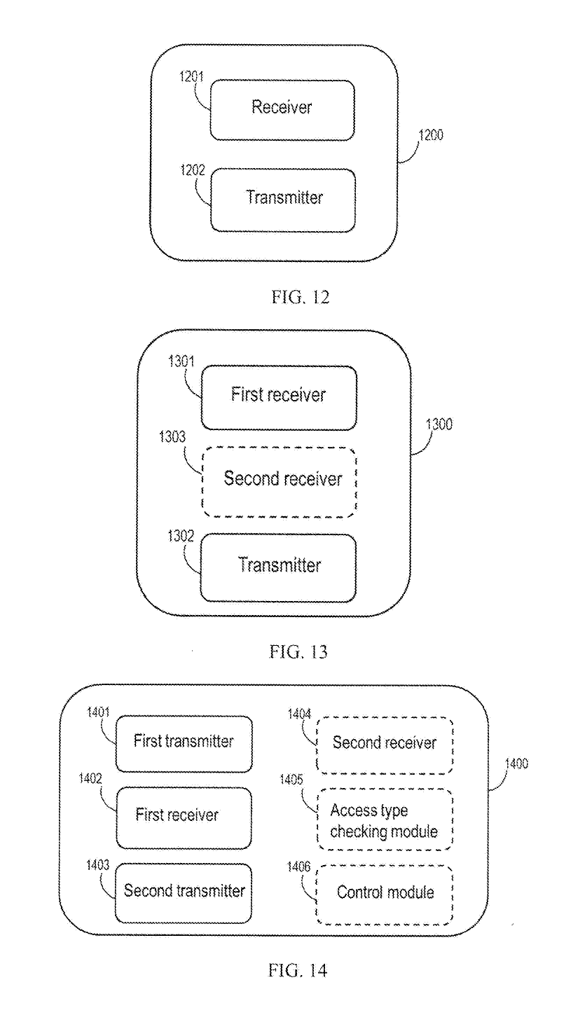

FIG. 12 illustrates a schematic block diagram of an apparatus 1200 adapted for facilitating located based services according to an embodiment of the present disclosure. The apparatus 1200 may be embodied at or as at least part of a third network node, for example but not limited to a PGW 423 shown in FIG. 4a.

As illustrated in FIG. 12, the apparatus 1200 comprises a receiver 1201 and a transmitter 1202. The receiver 1201 is configured to receive a message from a network node (e.g., an ePDG), the message comprising geographical location related information of a terminal connected to the first network node via non-3GPP access. The non-3GPP access can be IEEE 802. 11 public Wi-Fi access, for example. The transmitter 1202 is configured to transmit the geographical location related information to an IMS network via at least a network node for policy control function of the IMS network.

As one example, the receiver 1201 may be configured to receive the message from the network node by receiving a session creation request message from an ePDG. As another example, the transmitter 1202 may be configured to transmit the geographical location related information to an IMS network by transmitting the geographical location related information to a PCRF during a PCC session creation procedure or a PCC session update procedure.

In one embodiment, the geographical location related information transmitted by the transmitter may comprise at least one of: a local IP address of the terminal, both the local IP address and a port number of the terminal, and a geographical location of the terminal derived from at least the local IP address.

The above units 1201 and 1202 may be configured to implement corresponding operations or steps and to achieve corresponding technical effects as described with reference to method 600 and FIG. 6, and thus details will not be repeated here.

FIG. 13 illustrates a schematic block diagram of an apparatus 1300 adapted for facilitating located based services according to an embodiment of the present disclosure. The apparatus 1300 may be embodied at or as at least part of a fourth network node, for example but not limited to a PCRF 425 shown in FIGS. 4a-4c.

As illustrated in FIG. 13, the apparatus 1300 comprises a first receiver 1301 and a transmitter 1302. The first receiver 1301 is configured to receive a message from a network node (e.g., a PGW), the message comprising geographical location related information of a terminal connected to the network node via non-3GPP access (e.g., IEEE 802. 11 public Wi-Fi). The transmitter 1302 is configured to transmit the geographical location related information of the terminal to an IMS network.

In one embodiment, the first receiver 1301 is configured to receive a PCC session creation message or PCC session update message from a PGW, the geographical location related information of a terminal is included into the PCC session creation message or PCC session update message.

In another embodiment, the transmitter 1302 is configured to transmit the geographical location related information to the IMS network by transmitting the geographical location related information to the IMS network during an IMS registration or call procedure.

Optionally, the apparatus 1300 may further comprise a second receiver 1303 which is configured to receive an Authentication Authorization-Request (AAR) message from a P-CSCF, requesting geographical location related information. In one embodiment, the transmitter 1302 can be configured to transmit the geographical location related information to an IMS network by transmitting an AAA message or a Re-authentication Request (RAR) message including the geographical location related information to the P-CSCF in response to the AAR message received by the second receiver 1303.

In one embodiment, the above units 1301, 1302 and 1303 may be configured to implement corresponding operations or steps and to achieve corresponding technical effects as described with reference to method 700 and FIGS. 7a-7b, and thus details will not be repeated here.

FIG. 14 illustrates a schematic block diagram of an apparatus 1400 adapted for facilitating located based services according to an embodiment of the present disclosure. The apparatus 1400 may be embodied at or as at least part of a fifth network node, for example but not limited to a P-CSCF 426 shown in FIGS. 4a-4c.

As illustrated in FIG. 14, the apparatus 1400 comprises a first transmitter 1401, a first receiver 1402, and a second transmitter 1403. The first transmitter 1401 is configured to transmit a request to a network node (e.g., PCRF) requesting geographical location related information of a terminal accessed via non-3GPP access (e.g., IEEE 802.11 public Wi-Fi). The first receiver 1402 is configured to receive geographical location related information of the terminal from the network node in response to the requesting, and the second transmitter 1403 is configured to transmit the geographical location related information of the terminal to an IMS core.

Optionally, in one embodiment, the apparatus 1400 may further comprise a second receiver 1404 configured to receive a SIP REGISTER message from the terminal, and an access type checking module 1405 configured to determine the access type of the terminal based on the received SIP REGISTER message. In a further embodiment, the first transmitter 1401 may be configured to transmit a request to the network node (e.g., a PCRF) if the access type of the terminal is determined as non-3GPP access by the access type checking module 1405.

In a preferable embodiment, the first transmitter 1401 may be configured to transmit an Authentication Authorization-Request (AAR) message to a PCRF requesting for the geographical location related information of the terminal if the access type of the terminal is determined as IEEE 802. 11 by the access type checking module 1405.

In another embodiment, the first receiver 1402 can be configured to receive geographical location related information of the terminal from the network node by receiving from a PCRF an AAA message or a RAR message including the geographical location related information of the terminal.

In still another embodiment, the second transmitter 1403 is configured to transmit the geographical location related information of the terminal to an IMS core by transmitting a SIP REGISTER message including the geographical location related information of the terminal.

Alternatively or additionally, in one embodiment, the apparatus 1400 may further comprise a control module 1406 configured to apply a call restriction and/or a policy control to the terminal based on the geographical location related information. The geographical location related information may comprise at least one of: a local IP address of the terminal, both the local IP address and a port number of the terminal, and a geographical location of the terminal derived from at least the local IP address.

In one embodiment, the above units 1401 to 1406 may be configured to implement corresponding operations or steps and to achieve corresponding technical effects as described with reference to method 800 and FIGS. 8a-8b, and thus details will not be repeated here.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

A person skilled in the art shall appreciate that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method at a first network node for facilitating location based services and/or location based policy control, comprising:
receiving a message from a terminal connected to the first network node via non-Third Generation Partnership Project, non-3GPP, access, the message including a local IP address, or both the local IP address and a port number of the terminal; and
providing geographical location related information of the terminal to an IP Multimedia Subsystem, IMS, network via at least a network node for policy control function of the IMS network.

2. The method of claim 1, wherein receiving a message from a terminal comprises:
receiving an authentication request message from the terminal during an attach procedure of the terminal.

3. The method of claim 1, further comprising:
obtaining a geographical location of the terminal based on at least the local IP address prior to providing the geographical location related information of the terminal to the IMS network.

4. The method of claim 3, wherein obtaining the geographical location of the terminal based on at least the local IP address comprises:
providing the local IP address, or both the local IP address and the port number, to a second network node, and
receiving from the second network node the geographical location derived from at least the local IP address.

5. The method of claim 4, wherein the first network node is an Evolved Packet Data Gateway, ePDG, and the second network node is an Authentication Authorization and Accounting, AAA, server, and
wherein providing the local IP address, or both the local IP address and the port number, to a second network node, comprises: transmitting the local IP address or both the local IP address and the port number to the AAA server in a Diameter-EAP-Request, DER, request message, and
wherein receiving from the second network node the geographical location derived from at least the local IP address comprises: receiving the geographical location from the AAA server in a DER response message.

6. The method of claim 1, wherein providing geographical location related information of the terminal to an IMS network via at least a network node for policy control function of the IMS network comprises:
providing the geographical location related information via a Packet Data Network Gateway, PGW, to a Policy and Charging Rule Function, PCRF, during a Policy and Charging Control, PCC, session creation or update procedure.

7. The method of claim 1, wherein the geographical location related information of the terminal comprises at least one of:
the obtained geographical location,
the local IP address, and
both the local IP address and the port number.

8. A method for facilitating location based services and/or location based policy control, comprising:
receiving a local IP address or both the local IP address and a port number of a terminal from a first network node to which the terminal is connected via non-Third Generation Partnership Project, non-3GPP access,
deriving a geographical location of the terminal based on at least the local IP address; and
transmitting the derived geographical location to the first network node so as to enable the first network node to provide the geographical location to an IP Multimedia Subsystem, IMS, network.

9. The method of claim 8, wherein receiving a local IP address or both the local IP address and a port number of a terminal from a first network node comprises: receiving the local IP address or both the local IP address and the port number from an Evolved Packet Data Gateway, ePDG, in a Diameter-EAP-Request, DER, request message, and
wherein transmitting the derived geographical location to the first network node comprises: transmitting the geographical location to the ePDG in a DER response message.

10. The method of claim 8, wherein deriving a geographical location of the terminal based on at least the local IP address comprises:
translating the local IP address, or both the local IP address and the port number to the geographical location through a database.

11.-24. (canceled)

25. An apparatus in a network node, comprising a processor and a memory, said memory containing instructions executable by said processor whereby said apparatus is operative to perform the method according to claim 1.

26. An apparatus in a network node, comprising a processor and a memory, said memory containing instructions executable by said processor whereby said apparatus is operative to perform the method according to claim 8.

27.-55. (canceled)
